(19) United States
(12) Patent Application Publication
(10) Pub. No.: US 2015/0032535 A1
(43) Pub. Date: Jan. 29, 2015

(54) SYSTEM AND METHOD FOR CONTENT BASED SOCIAL RECOMMENDATIONS AND MONETIZATION THEREOF

(71) Applicant: YAHOO! INC., Sunnyvale, CA (US)

(72) Inventors: Jia Li, Santa Clara, CA (US); David Shamma, San Francisco, CA (US)

(73) Assignee: YAHOO! INC., Sunnyvale, CA (US)

(21) Appl. No.: 13/951,078

(22) Filed: Jul. 25, 2013

(51) Int. Cl. G06Q 50/00; G06Q 30/02

(52) U.S. Cl. CPC G06Q 50/01; G06Q 30/0255
USPC 705/14.53

(57) ABSTRACT

Disclosed is a system and method for automatically detecting social relationships from consumer image collections. The disclosed systems and methods provide the ability to infer relationships between people thereby creating dynamic social networks from the occurrences of people appearing in digital images. Occurrences of people in pictures can be detected based on known or to be known facial recognition technology. These inferences enable relationship determinations regarding whether the people are family members, friends, acquaintances or merely strangers who happen to be in the same place at the same time. The disclosed detection of such relationships enables the building of intelligent image management systems. Furthermore, based on the detected social relationships, advertisements can be served not solely to a single person, but to multiple people within the scope of the social relationship

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to inferring social relationships from personal image collections, and more particularly to a system and method for establishing dynamic social relationships based on shared content between users and monetizing such relationships.

### RELATED ART

In recent years due to the pervasiveness of digital cameras and camera-phones, there has been an exponential increase in the overall number of photos taken by users. This dramatic growth in the amount of personal digital media has led to increasingly large media libraries in online repositories. Large photo collections turn the manual task of selecting images and identifying content represented by such images into a tedious and time consuming process. Additionally, the familiarity users have with the photos belonging to specific events decay over time, turning the photo selection task more difficult with time.

### SUMMARY

The present disclosure discloses an automatic approach to personal photo collection clustering, summarization and event detection. The present disclosure provides an improved process for classifying content and developing relationships with individuals depicted in or associated with a digital image, particularly when such digital image is a part of a large collection of digital images. Furthermore, identifying faces via commenting, tagging or other types of feedback (e.g., people from the image collections) in a large database of images can be time consuming as the number of known faces increases, and/or is inaccurate. It is desirable that this recognition execution time be reduced.

Thus, the present disclosure discloses systems and methods for automatically detecting social relationships from consumer image collections. The disclosed systems and methods provide the ability to infer relationships between people thereby creating ad hoc or dynamic social networks from the occurrences of people appearing in digital images. For example, relationships can be inferred between people appearing in the same picture. In some embodiments, occurrences of people in pictures can be detected based on known or to be known facial recognition technology. Such inferences may also be in conjunction with other user data present on the network. As discussed herein, these inferences enable relationship determinations regarding whether the people are family members, friends, acquaintances or merely strangers who happen to be in the same place at the same time. The disclosed detection (or prediction) of such relationships enables the building of intelligent image management systems. Furthermore, based on the detected social relationships, advertisements can be served not solely to a single person, but to multiple people within the scope of the social relationship.

In accordance with one or more embodiments, a method is disclosed which includes identifying, via a computing device, an image collection associated with a first user within a photo-sharing network; parsing, via the computing device, each image in the image collection to identify content of each image; determining, via the computing device, a first content category based on the content of each image; grouping, via the computing device, each image associated with the first content category into a first image cluster; analyzing, via the computing device, each image of the first cluster to determine an occurrence of a digital representation of a second user within the first cluster, providing, via the computing device, a recommendation to the first user and the second user, said recommendation facilitating a social relationship between the first user and the second user within the photo-sharing network; and serving, via the computing device, an advertisement to the first user and the second user in accordance with the recommendation and based on the first content category.

In accordance with one or more embodiments, a non-transitory computer-readable storage medium is provided, the computer-readable storage medium tangibly storing thereon, or having tangibly encoded thereon, computer readable instructions that when executed cause at least one processor to perform a method for establishing dynamic social relationships based on shared content between users and monetizing such relationships.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating a client device in accordance with some embodiments of the present disclosure;

FIG. 3 is a schematic diagram of a system capable of identifying social connections and relationships based on media content according to some embodiments of the present disclosure;

FIG. 4 is a flowchart illustrating steps performed in accordance with an embodiment of the present disclosure;

FIG. 5 is a flowchart illustrating steps performed in accordance with an embodiment of the present disclosure;

FIG. 5A is a flowchart illustrating steps performed in accordance with an embodiment of the present disclosure;

FIGS. 6A-6C illustrate examples social networks and connections in accordance with an embodiment of the present disclosure;

FIG. 7 is a flowchart illustrating steps performed in accordance with an embodiment of the present disclosure;

FIGS. 8A-8B illustrate examples of serving advertisements in accordance with embodiments of the present disclosure; and

FIG. 9 is a block diagram illustrating architecture of a hardware device in accordance with one or more embodiments of the present disclosure.

### DESCRIPTION OF EMBODIMENTS

The present disclosure will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS). General Packet Radio Services (GPRS), Enhanced Data GSM Environment (EDGE), 3GPP Long Term Evolution (LTE), LTE Advanced. Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, Flickr®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

The principles described herein may be embodied in many different forms. Generally, the described systems and methods are directed towards determining social connections and relationships between people based on media content located within a user's image collection. The present disclosure leverages media content within a user's image collection in order to develop social connections and relationships with other users identified from the image collection. Embodiments of the present disclosure involve image collections within a photo-sharing network, site or service. That is, the present disclosure operates as part of, or in connection with, a multi-online photo management site (or service), such as such as Flickr®, Instagram®, Picasaweb®, or other social networking sites, e.g., Facebook®, MySpace®, Google+®, Twitter®, and the like. However, it should be understood that while the present disclosure is discussed with reference to a photo sharing and social site, specifically Flickr®, it should be understood that additional embodiments exist and are within the scope of the methods and systems discussed herein involving other types of social networking sites and web sites and pages, e.g., news, business, sports, education, leisure, art, blogging, and the like. Additionally, while the discussion herein is directed towards media content and information derived from images or collections of images (e.g., digital photographs), the present disclosure should not be construed to be limited to, or focused solely upon these types of media content. That is, the present disclosure includes embodiments involving both motion and non-motion imagery, and any other data or content interacted with or consumed by a user.

Currently, through the use of digital photography, users are able to capture and store large collections of personal digital images. These images are typically stored in an online photo management service/site which maintains digital image collections for a large number of users. On-line photo sharing websites have a large, untapped potential in attracting social activities. For example, a small portion of socially active users add contacts, tag, comment, favorite other photos and join groups. However, a large portion of users do not actively participate in these activities. For example, such users, e.g., inactive users, do not know of interest groups which are related to their expressed interests. In fact, some users do not even know their friends' usernames. Typically, these users store photos or browse others photos without providing any feedback, e.g., favorite, tagging and/or comments, and the like.

The present disclosure provides systems and methods of connecting people by recommending social connections and/or proposing groups based on social activity of a user(s). Specifically, the disclosed systems and methods analyze user's image collections in order to identify common interests between users. Based on this analysis, recommendations are generated between users who share common interests. As discussed in more detail below, the discussion herein involves identifying a user's image collection, and through an analysis of the images, the images are clustered according to specific parameters, such as type of content. For example, if user A goes on vacation to Texas, and uploads the Texas vacation pictures to Flickr®, these pictures can span an array of topics, some related and others unrelated. For example, a broad topic of “Texas” could include all the activities. However, the photo album for the vacation may include pictures corresponding to tourism (upon visiting the Alamo), baseball (upon visiting Rangers Stadium), basketball (upon attending a Spurs game), food and wine (upon visiting the local restaurants) and the like. Therefore, even though all of these images are located within an album, they may not all be contextually related. Thus, even images within an album, or spanning multiple albums associated with a user, e.g., primary user, may be analyzed to determine the type of content.

Thus, as discussed in more detail below, images within a user's image collection are analyzed from a content perspective in order to ascertain the type of content that each image is related towards. Although images are usually organized in albums within a larger directory, these images typically do not relate towards the same subject matter. By way of another example, user A has a large image collection on Flickr® containing images from the user's trip to New York. During the trip, pictures were taken and uploaded to Flickr® related to user A's trip to the Statute of Liberty and his attendance at a New York Knickerbocker's game. Therefore, these images can be clustered and/or parsed based on their image content, as discussed in more detail below. That is, the images can be clustered according to a category for “tourism” and “sports”, respectively. After this clustering, each image cluster (or category) is analyzed to identify individuals in the images. This identifying includes, but not limited to, facial recognition analysis performed on the images to identify the person(s) in each picture. Electronic processing is initiated for each image within the derived image clusters to recognize, or identify one or more people from the image. According to some embodiments, from this analysis and processing, presentation of an option to the user is effectuated in order to provide a friend recommendation or group recommendation based on the people recognized from the images. Within this presentation, the disclosure involves determining whether the one or more identified people are associated with a member account of the user (or of the networking service (e.g., Flickr®). In some embodiments, overlapping communities can be identified and established between the image clusters and/or other users, as discussed below.

Additionally, as discussed in more detail below, advertisements can be served to the user, and/or user groups. These advertisements will be based on content of the images, thereby increasing the probability that the users will have an interest in the advertisement. For example, from user A's image at a basketball game, user B is identified and user A is presented with a friend recommendation for user B. After establishing the social relationship, an advertisement can be presented to both user A and user B which is related towards sports, or specifically to basketball tickets and/or equipment, as these users have an established interest in the sport based on their presence within an image identified as relating to basketball.

Therefore, according to some embodiments, the described systems and methods allow for automatic detection of social relationships between users from online image collections. The present disclosure provides systems and methods for learning a user's contacts and interests and automatically suggesting friends and/or interest groups to the user. In some embodiments, the groups recommended to the user need not be existing groups as they can be created and recommended based on a user(s) behavior or social activity. For example, groups may be established for users who are interested in the same type of photos (e.g., baby photos or basketball photos). Groups may also be established for users who share similar properties, such as colleagues, classmates, or those users who share similar demographic information, and the like.

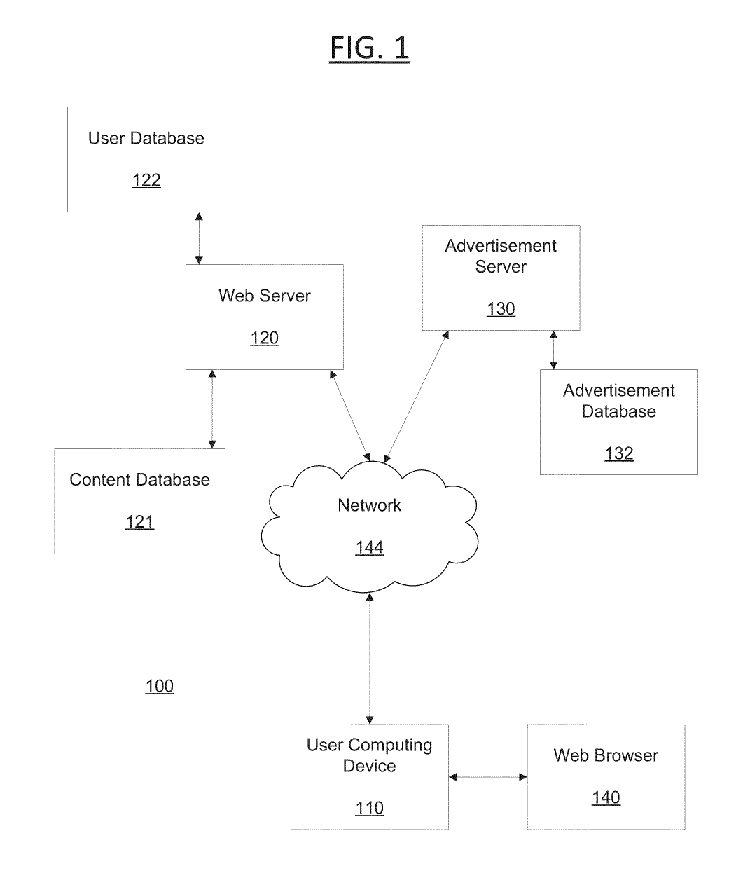

Certain embodiments will now be described in greater detail with reference to the figures. In general, with reference to FIG. 1, a system 100 in accordance with an embodiment of the present disclosure is shown. The user can access content from a user computing device 110. The content may be provided by web server 120 over network 144. Thus, in order to provide the content, the web server 120 may be associated with a content database 121 (or online repository). Content within the content database 121 can include media or multimedia, and such content may be annotated. Examples of content may include images, text, audio, video, or the like, which may be processed in the form of physical signals, such as electrical signals, for example, or may be stored in memory, as physical states, for example. Content may be contained within an object, such as a Web object, Web page, Web site, electronic document, or the like. An item in a collection of content may be referred to as an “item of content” or a “content item,” and may be retrieved from a “Web of Objects” comprising objects made up of a variety of types of content. The term “annotation,” as used herein, refers to descriptive or contextual content related to a content item, for example, collected from an individual, such as a user, and stored in association with the individual or the content item. Annotations may include various fields of descriptive content, such as a rating of a document, a list of keywords identifying topics of a document, and the like.

Thus, it should be understood that the web server 120 can be referred to as a “content server.” A content server may include a device that includes a configuration to provide content via a network to another device. A content server may, for example, host a site, such as a social networking site, examples of which may include, without limitation, Flickr®, Twitter®, Facebook®, LinkedIn® Google+®, or a personal content site (such as a blog, vlog, online dating site, etc.). A content server may also host a variety of other sites, including, but not limited to image hosting sites, business sites, educational sites, dictionary sites, encyclopedia sites, wikis, financial sites, government sites, and the like.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, and the like.

According to some embodiments, the present disclosure may also be utilized within a photo-sharing site such as a social network. A social network refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. In some embodiments, multi-modal communications may occur between members of the social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, set-top boxes, SMS/MMS, email, instant messenger clients, forums, social networking sites, or the like.

An advertisement may be served to user computing device 110 from advertisement server 130 over the network 144. Each of user computing device 110, web server 120 and advertisement server 130 can be communicatively coupled via the network 144, such as the Internet. Although different steps are being performed by the web server 120 and the advertisement server 130, it should be noted that any one or more of the steps can be performed by either of the web server 130 and the advertisement server 130, or the function can be combined in a single server.

In accordance with some embodiments, the ad server 130 and the web server 120 can be a single server or multiple servers, and can be at a single location or multiple locations. Portions of advertisement content and advertising metadata may be stored at advertisement database 132. Advertising content and metadata can be accessed by and served from advertisement server 130 to the user computing device 110 based upon content type, content category, keywords, tags or other information known about each portion of content being transmitted by the web server 120. Additionally, ad content and metadata can be served based on user information, e.g., user relationships, which are stored at user database 122, as described in further detail below.

The user database 122 may be based upon a profile builder, as understood by those of skill in the art. A profile builder may initiate generation of a profile, such for users of an application, including a social site application, for example. A profile builder may initiate generation of a user profile for use, for example, by a user, as well as by an entity that may have provided the application. For example, a profile builder may enhance relevance determinations and thereby assist in developing relationships between other users, indexing, searching or ranking served advertisements, search results, and the like. Therefore, an ad serving engine may employ a profile builder, for example.

A variety of mechanisms may be implemented to generate a profile including, but not limited to, collecting or mining navigation history, stored documents, tags, or annotations, to provide a few examples. A profile builder may store a generated profile. Profiles of users of a search engine, for example, may give a search engine provider a mechanism to retrieve annotations, tags, stored pages, navigation history, or the like, which may be useful for making relevance determinations of search results, such as with respect to a particular user.

An ad server 130 comprises a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user. Such sponsored advertising includes monetization techniques including sponsored search advertising, non-sponsored search advertising, guaranteed and non-guaranteed delivery advertising, ad networks/exchanges, ad targeting, ad serving and ad analytics.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers. For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s). Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

User computing device 110 includes a web browser 140, or other program for interfacing with the network. The web server 120 provides content, e.g., Web pages, which are accessible by the user computing device 110. One of the Web pages includes reference to the advertisement. Such an advertisement, which may contain portions written in HTML, XML, Macromedia Flash, Java, JavaScript, and the like, is served by advertisement server 130, as is generally known in the art.

It is to be understood that the present disclosure may be implemented utilizing any number of computer technologies. For example, although certain embodiments relate to providing access to content via the Internet, the disclosure may be utilized over any computer network, including, for example, a wide area network, local area network or, corporate intranet.

Similarly, the user computing device 110 may be any computing device that may be coupled to the network 144, including, for example, personal computers, game consoles, smart TVs, personal digital assistants. Web-enabled cellular telephones, devices that dial into the network, mobile computers, tablet computers personal computers, Internet appliances, wireless communication devices and the like. Furthermore, the servers described herein may be of any type, running any software, and the software modules, objects or plug-ins may be written in any suitable programming language.

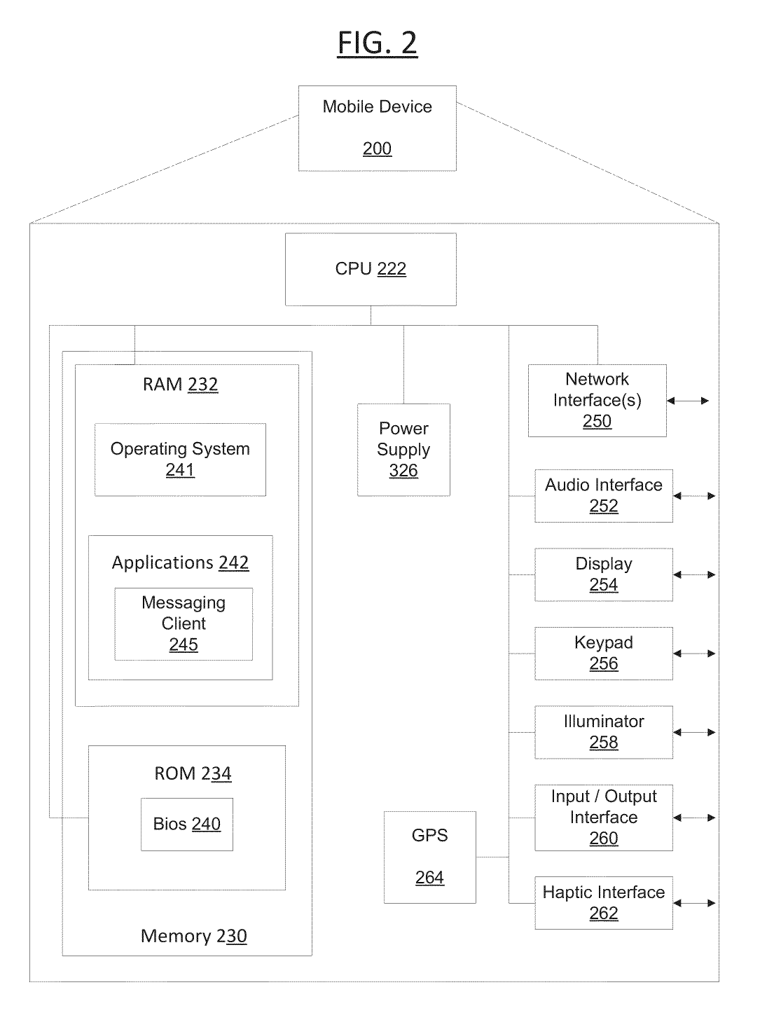

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to Client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling Client device 200 to one or more networks, and is constructed for use with one or more communication protocols and technologies including, but not limited to, global system for Client communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when the Client device 200 receives a communication from another user.

Optional GPS transceiver 264 can determine the physical coordinates of Client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. It is understood that under different conditions, GPS transceiver 264 can determine a physical location within millimeters for Client device 200; and in other cases, the determined physical location may be less precise, such as within a meter or significantly greater distances. In one embodiment, however, Client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of Client device 200. The mass memory also stores an operating system 241 for controlling the operation of Client device 200. It will be appreciated that this component may include a general purpose operating system such as a version of UNIX, or LINUX™, or a specialized client communication operating system such as Windows Client™, or the Symbian® operating system. The operating system may include, or interface with a Java virtual machine module that enables control of hardware components and/or operating system operations via Java application programs.

Memory 230 further includes one or more data stores, which can be utilized by Client device 200 to store, among other things, applications 242 and/or other data. For example, data stores may be employed to store information that describes various capabilities of Client device 200. The information may then be provided to another device based on any of a variety of events, including being sent as part of a header during a communication, sent upon request, or the like. At least a portion of the capability information may also be stored on a disk drive or other storage medium (not shown) within Client device 300.

Applications 242 may include computer executable instructions which, when executed by Client device 200, transmit, receive, and/or otherwise process audio, video, images, and enable telecommunication with another user of another client device. Other examples of application programs include calendars, browsers, contact managers, task managers, transcoders, database programs, word processing programs, security applications, spreadsheet programs, games, search programs, and so forth. Applications 242 may further include messaging client 245 that is configured to send, to receive, and/or to otherwise process messages using SMS, MMS, IM, email. VOIP, and/or any of a variety of other messaging communication protocols. Although a single messaging client 245 is illustrated it should be clear that multiple messaging clients may be employed. For example, one messaging client may be configured to manage SMS messages, where another messaging client manages IM messages, and yet another messaging client is configured to manage serving advertisements, emails, or the like.

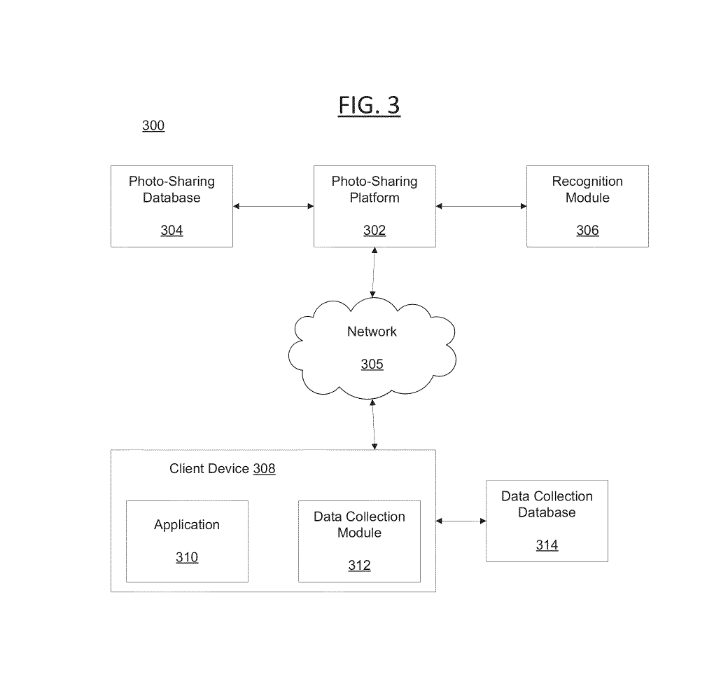

Having described the components of the general architecture employed within the disclosed systems and methods, the components general operation with respect to the disclosed systems and methods will now be described with reference to FIGS. 3-9. FIG. 3 is a diagram of a system 300, according to some embodiments of the present disclosure, that is capable of creating social connections and relationships based on media content, as discussed herein.

By way of background, with today's social networking and photo-sharing services, it is increasingly desirable to add people to a user's network. These people can be employers, colleagues, friends, acquaintances, or person that a user might meet. Typically, adding a person to a user's network involves the exchange of some personal information (e.g., an e-mail address, a username, address, name, and the like). Additionally adding a person to a user's network can involve logging into a service, recommending users and/or groups, and sending an invitation. This can be difficult to accomplish when a user meets a person on the street, or forgets a portion of personal information given, or is unable to attain the requisite for personal information.

System 300 of FIG. 3 provides the capability to create social networking relationships based on media content stored within a user's image collection on a networking site, e.g., Flickr®. That basis of shared exposure or instances of media content (e.g., a digital image, a video, audio, and the like) can be used to invite a person to a user's social network. As depicted in FIG. 3, a system 300 involves a client device 308 having connectivity to a photo-sharing platform 302, e.g., Flickr®, over a communication network 305. As discussed above, it should be understood that the embodiments discussed herein, while focused towards photo-sharing sites/services/network, are not limited as such, and can be utilized within, as part of, or entirely within known or to be known social networking platforms.

The device 308 can utilize a photo sharing application 310 to receive services from the photo sharing platform 302. The device 308 can also have an associated data collection module 312 to collect media content, and an associated data collection database 314 to store the media content. The media content can be transmitted to the photo sharing platform 302. The photo sharing platform 302 can store the media content in a photo sharing database 304. The photo sharing platform 302 can also process the media content via a recognition module 306 to recognize that a person is captured in the media content by extrapolating user data associated with the person by using a recognition module. This user data can include, but is not limited to, social data associated with a user, contact information, profiles, relationship data, facial recognition definitions, data and information, demographic data, biometric data, and the like, and can be stored in the photo sharing database 304. In one embodiment, the user data can be stored separate from the media content to efficiently use space by not storing the media content.

In exemplary embodiments, the system 300 includes a recognition module 306. A recognition module 306 can extrapolate user data from media content to recognize identifying information of a person. As discussed in more detail below, identifying a person (e.g., a digital representation of a user) from the media content, e.g., photo, can be based known or to be known facial recognition algorithms. In some embodiments, the recognition module 306 can also be used to compare two sets of user data to determine if the two sets match within a certain threshold. In one embodiment, the media content can include, but is not limited to, an image, a video, and the like. In an embodiment, the recognition module 306 can determine if an image (e.g., a digital image, a three-dimensional image, an infrared image, and the like) includes a person that can be recognized. An image can be scanned or parsed to determine selected facial features from the image. The facial features can then be compared to facial features stored in a database. In some embodiments, the recognition module 306 can determine attributes of the person(s) based on three-dimensional visual cues or biometric data in the picture. In some embodiments, two images of a person can be matched if the features match within a certain probability, range or threshold. Embodiments of the determinations for recognizing a person will be discussed in more detail below.

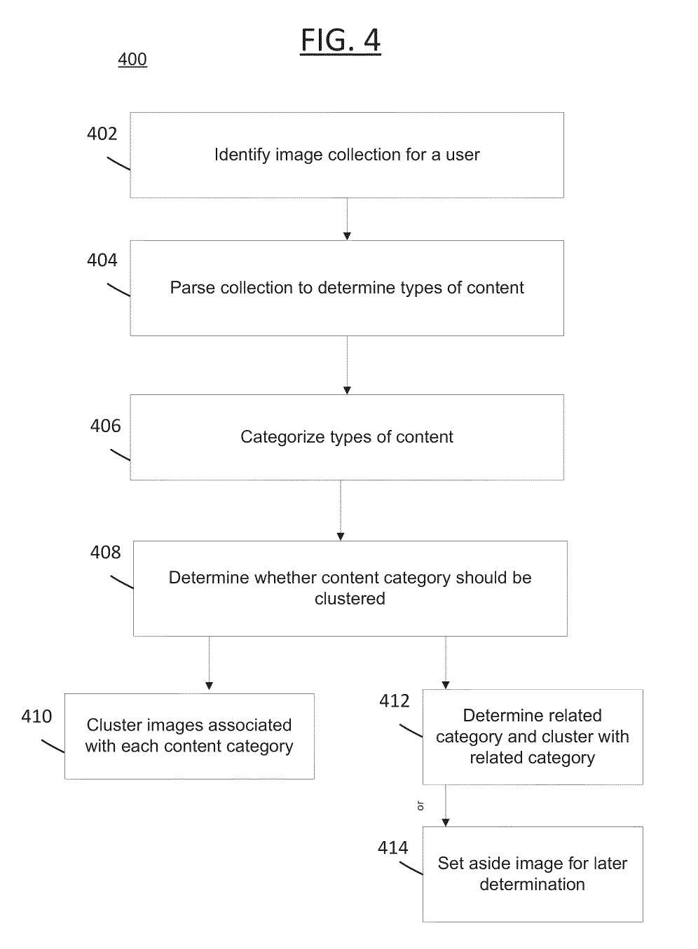

As discussed above, the present disclosure involves determining social connections and relationships between people based on specific media content located within a user's image collection. FIG. 4 illustrates a process 400 for determining the specific media content within a user's image collection. Specifically, the present disclosure leverages the identified content of each image within a user's image collection into creating specific clusters from the user's image collection. As discussed above, a user's image collection is utilized (e.g., analyzed, parsed and/or clustered) in identifying and determining social connections with other users. Specifically, instances of other user's appearing in, or within, images contained within a user's image collection are the basis for recommending such social connections. As in Step 402, a user's image collection is identified. As referred to herein, the user's collection which is utilized to build clusters and ultimately social relationships, as discussed below, will be referred to as the “primary user”. In some embodiments, a user's collection can be maintained on a photo-sharing site; however, embodiments exist where the collection can be located locally on a user's device, in the cloud, or any other local or remote location. The collection can include images a user has uploaded, viewed, tagged, downloaded, and the like. These images are then clustered based on content. That is, the images within the collection are clustered according to similarities in content, as discussed in the steps below.

In Step 404, the user's image collection is analyzed to determine the categories or types of content contained within the collection and/or the content appearing within the images. These types of content can be based on a multitude of factors. For example, if the user's collection comprises an array of albums, then the albums can be utilized to identify the types of content. For example, if the collection has albums for sports, work events, and holidays, some embodiments can utilize these album identifiers in clustering the images according to the predefined designations. In some embodiments, the images, whether pre-categorized into albums or not, will be analyzed based on content and metadata associated with the image. Categories of content from the image(s) (e.g., specific content) can be determined by analyzing information including content and/or metadata associated with each image (or in some embodiments the collection as a whole). In Step 406, the identified content is then categorized according to the type of content. For example, if a user's collection comprises images (e.g., content) related to sports, news and leisure, the images can be categorized for the content types (or categories): sports, news and leisure.

In exemplary embodiments, the information utilized to compile cluster categories can be derived from the content or data a user creates; content or information a user renders; features around images that a user uploads/downloads; descriptions, tags, comments and image features including geo-data and exchangeable image file format (exif) data related to the content. Additionally, cluster categories can be determined based upon the features related to images that a user views; social circles (including social-graph data); search session, image categorical data, and the like. Indeed, clusters can be determined based in part upon user profile information across network platforms, e.g., Yahoo!® network, including search, finance, sports, music content, and the like. Thus, cluster categorizes can be based on information that specifies the types and formats for images, sound, video, and ancillary metadata (or tags) associated with the content the user renders and the users themselves. Such metadata can include, but is not limited to, digital data including type, format, data and time information, description information, source information, copyright information, geo-location information, compression data, security information, and the like. This information can be contingent upon the device(s), users or platforms used to create, view or upload the content. In another example, from a collection of images from user A's trip to Paris, France, the images can be analyzed to identify specific landmarks appearing in the image. That is, for images that were taken at the Eifel Tower, these images can be clustered together. Also, images taken at the Louvre Museum can also be separated out and grouped (or identified) as a separate cluster.

In some embodiments, in order to avoid one-off, or a low quantity of images having the same or similar content without common similarities to other images, a threshold must be met in order to properly and efficiently categorize images for the purposes of this disclosure. That is, a threshold must be met in clustering a content category. Step 408. The threshold for identifying content for clustering can be determined (or predetermined) as per designations set by the photo-sharing site, user, system as a whole, an advertiser, and the like, and/or by any combination therewith. For example, if a collection of images comprises images related to baseball, cooking and nature, and there is a single image (or a number of images below a threshold) related to football, then, the clustering will involve only baseball, cooking and nature, where the football picture could be classified with the baseball cluster due to its relationship to a broader category: sports. In some embodiments, if a cluster category does not satisfy the threshold, that corresponding image(s) can then be grouped with another cluster, Step 412, or set aside for future designation, Step 414. As discussed below, users and/or user relationships can be associated with specific clusters, and served advertisements based upon their associated clusters. It should be understood that the examples of clusters listed above are non-exhaustive, and the possibility of clusters having multiple sub-clusters, and sub-clusters having multiple sub-clusters is included within the scope of the present disclosure.

In Step 410, the images for each category are clustered. That is, based on the above information derived from Steps 402-408, clusters are created. Clusters can be determined to include, but are not limited to, specific (or categorized) content sets. For example, clusters can be related to categories for “concert shows”. “travel”, “life events”, and the like. Additionally, clusters may include sub-clusters. For example, travel clusters can include multiple sub-clusters depending on the travel concepts: city, beach, snow/ski, road trips, region, and the like. Life events can also include multiple sub-clusters: marriage, baby pictures, graduation, and the like. Thus, the present disclosure can employ categorizers using logistic regression or learning models including support vector machines (SVMs) to map these clusters into predefined nodes in a business taxonomy, which are then utilized in behavior targeting by advertisers. It should be understood that known or to be known learning algorithms and models that analyze data and recognize patterns for classification and regression analysis can be utilized in accordance with the present disclosure.

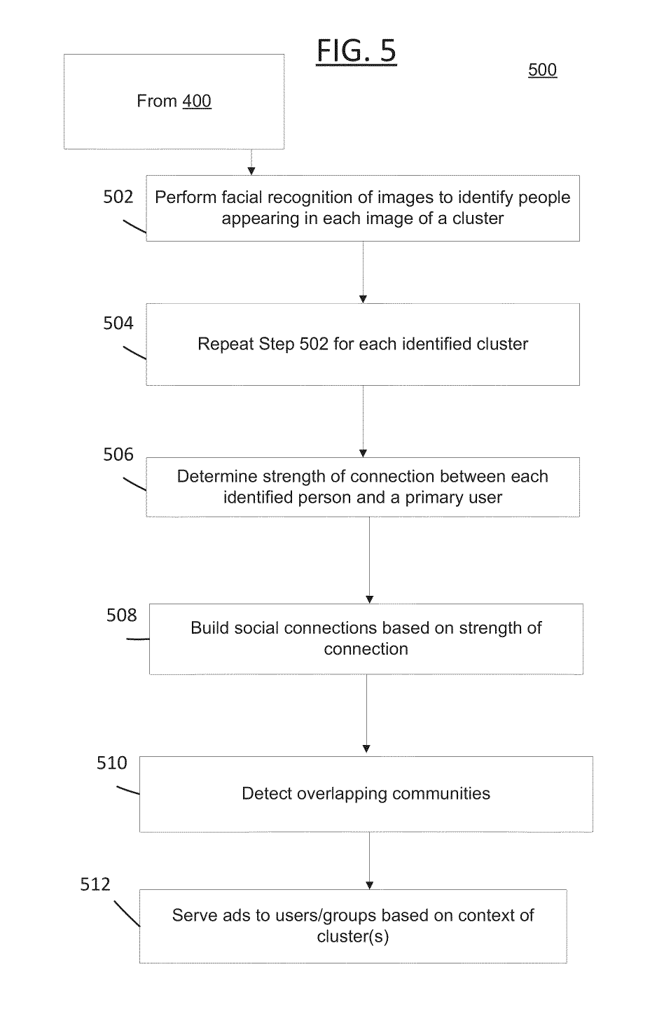

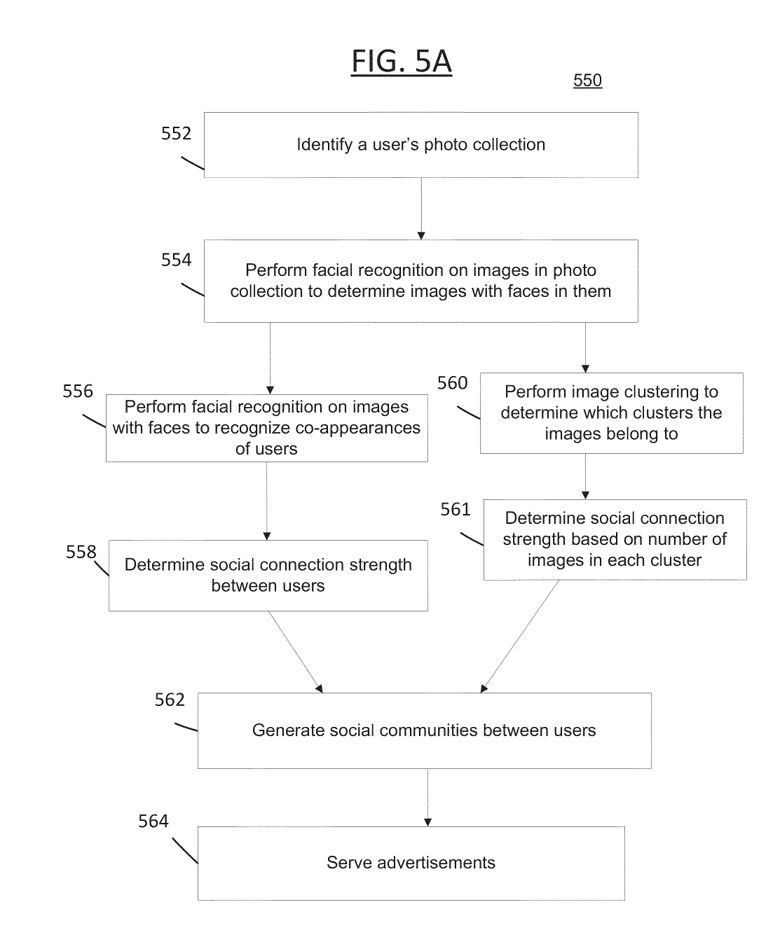

FIG. 5 illustrates the process 500 for determining social relationships based on the clustered images from FIG. 4. As discussed below, process 500 of FIG. 5 elaborates on building social relationships and connecting users based on shared clusters. That is, a social network can be built from the photo content analysis of each cluster. The steps performed within process 500 are performed by the recognition module 306 from FIG. 4. These steps are performed for each cluster identified from process 400. As understood from the below discussion, the following steps can occur at the same time for each cluster, in that they are each simultaneously analyzed, or can occur iteratively.

In Step 502, the recognition module 306 performs electronic processing of each image within an identified cluster to recognize one or more people within each image. In exemplary embodiments, the electronic processing can be based upon facial recognition algorithms or other known or to be known recognition algorithms. Some embodiments utilize the facial recognition algorithms discussed in “Digital Paparazzi: Spotting Celebrities in Professional Photo Libraries,” by S. Jafarpour, L. Li and R. van Zwol, 11th Asian Conference on Computer Vision, Daejeon, Korea, Nov. 5-9, 2012. Revised Selected Papers, Part II, pages 694-707, which is incorporated herein by reference. Thus, according to some embodiments, known or to be known recognition algorithms can be utilized to automatically identify and/or verify a person from a digital image or a frame from a content source. That is, the electronic processing of Step 502 extracts information identifying each person recognized from the image. The applied recognition algorithm then verifies the person's identity based on data complied during the identification process of Step 502. The verification can be based upon information associated with the recognized person including, but not limited to, demographic information, age, gender, biometric, and other types of information derivable from such image and facial recognition processing, or extracted from a user's profile, as understood by those of skill in the art. For example, for each identified person, the extracted information is used to identify user profile information of the identified other user's within the network. Thus, other user's information (e.g., profile information) can then be utilized for the recommendation process discussed below. The recognition process of Step 502 is repeated for each image within an identified cluster and for each cluster of images identified from process 400, discussed above. Step 504.

In Step 506, the connection strength between the primary user and each recognized person is determined. This determination is based on the number of times the person is identified within an image. That is, for each time a person is identified and recognized within an image, a connection score is incremented reflecting the strength of the connection between the identified person and the primary user. In some embodiments this occurs across identified clusters. In some embodiments, this occurs for each cluster. For example, user A has a cluster of images that has 10 images. Within the cluster, Spencer is identified 8 times and John is identified 6 times. Therefore, within the cluster, Spencer has a stronger tie to user A than John. In another example, user A has two clusters, each with 10 images, and categorized to golf and hiking, respectively. In the sports cluster, Spencer is identified 6 times and John is identified 5 times. In the hiking cluster, Spencer is identified 6 times, and John is identified 8 times. Therefore, as above, for the sports cluster, Spencer has a stronger tie to user A, while in the hiking cluster, John has a stronger tie. However, according to some embodiments, if the strength of connection (or relationship) is predicated upon overall strength, then John in this example would have a stronger connection than Spencer to user A. As discussed above with respect to the clustering of images, for a user to register a score determinable for compiling a strength connection/score/tie with user A, it must meet a certain threshold, which according to some embodiments, can be set by the user, system, photo-sharing site, advertiser, or combination thereof.

In Step 508, based on the identified person(s) within the images, and the strength of connection, a social network is compiled (or built) for user A. This involves providing user A with friend recommendations or group recommendations. That is, from the above example, since Spencer is identified more times than John in the sports cluster, user A and Spencer can be provided with an invitation to become “friends” within the photo-sharing site. Also, from the data compiled from the hiking cluster, John and user A can receive an invitations (or recommendation) to become “friends.” In some embodiments, only the person with the highest or strongest connection will be “recommended.” In some embodiments, all connections at or above a threshold will be recommended, as discussed herein. Therefore, if the threshold is, for example, set at 30% of the images within a cluster having the same identified person, then within both the sports and hiking context, Spencer and John would be recommended to user A to become “friends” (or a group recommendation as discussed below). In some embodiments, these invitations can be respective of, or within the scope of the cluster from which the invitation was generated from. That is, in some embodiments, because Spencer was “recommended” to user A from a “sports” perspective, Spencer, as a “friend” may only be able to view sports content on user A's profile/site/page. Similarly for John within the “hiking” scope of user A's page. Additionally, the recommendation may further be based upon a relationship to the primary user. That is, recommendations can be further based upon whether the recommended party is an employer, colleague, family, friend, acquaintance, or person that a user might meet. This further designation can be based upon, but is not limited to, social data associated with the primary user, contact information, profiles, relationship data, facial recognition definitions, data and information, demographic data, biometric data, and the like. According to some embodiments, users may also be automatically added (or join a group). This can occur for those users having the strongest connection with a user.

In a similar manner, user A can be provided with group recommendations. These recommendations can be respective of joining existing groups related to the content of the clusters. Additionally, if a group does not already exist, a group recommendation can be provided to users in order to create a group upon the users joining the group.

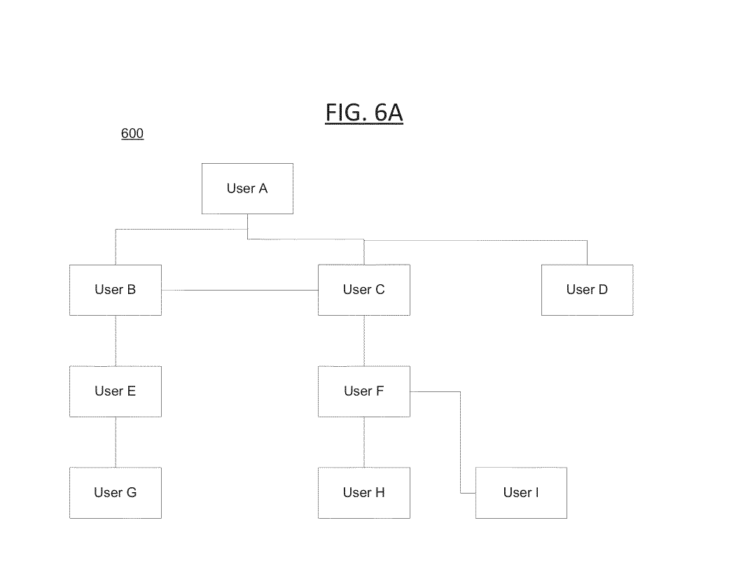

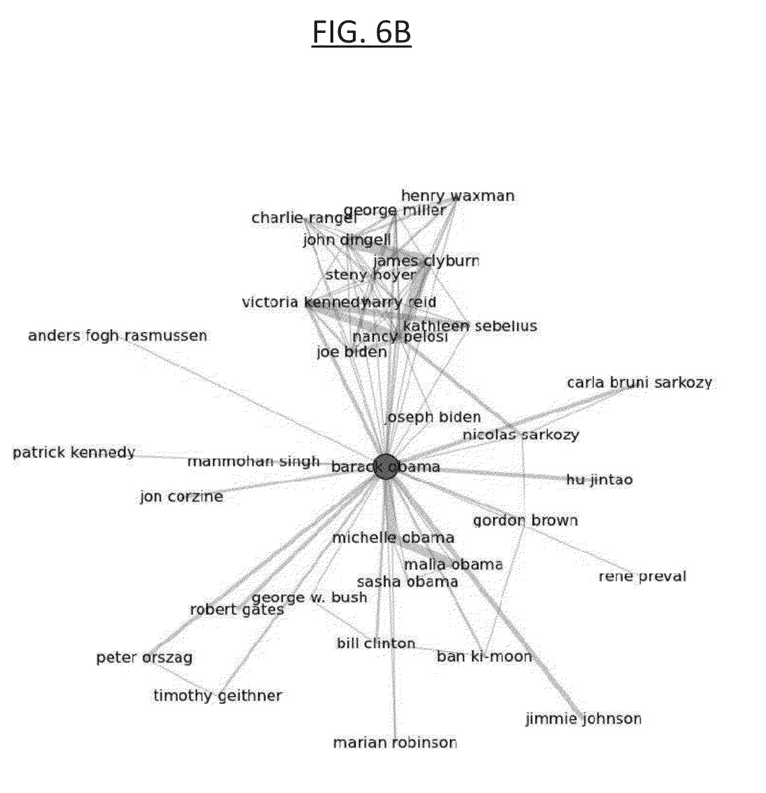

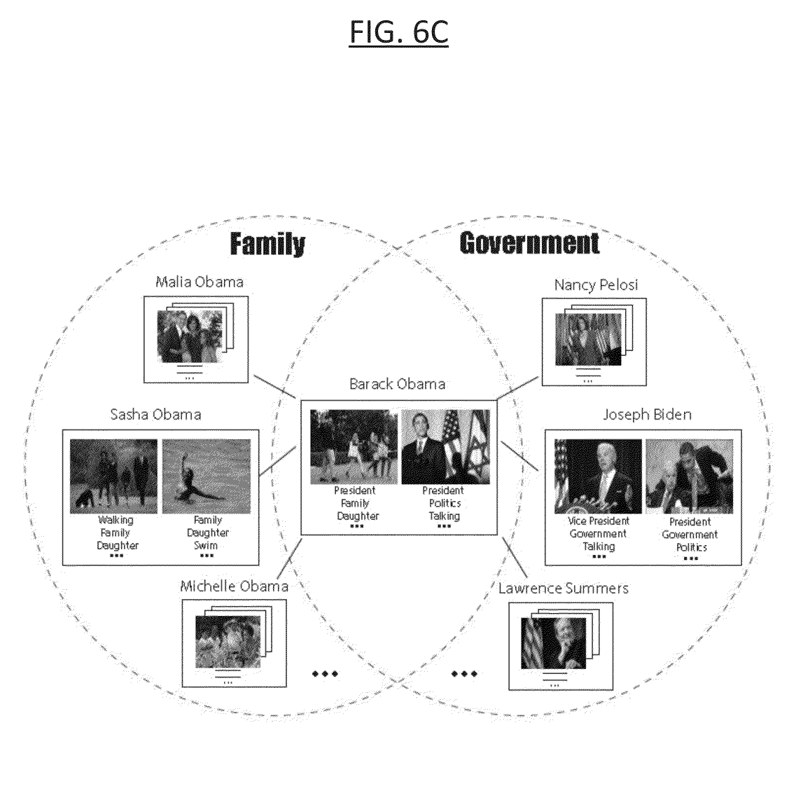

In Step 510, overlapping communities are detected, if any. That is, the process 500 then determines if there are any overlapping communities, or users/friends, or groups respective of the primary user. From the above example, user A has a connection with John within the hiking context. John as connections with Brad and Sean within the same context, therefore an overlapping community is detected, and user A can be provided with recommendations to become friends, or form (or join) a group with Brad and Sean. It should be understood that the context of forming and generating recommendations may not only be based on the context of the connection with a primary user. Additionally, the connection between a primary user and other user's may be additionally based on additional contexts. For example, from the above example, if Spencer is user A's co-worker, and John is user A's brother, the connection may be further weighted to enable a stronger connection between family members over co-workers. That is, inferences can be made based upon user A's user data (e.g., profile data) thereby enabling relationship determinations regarding whether the people are family members, friends, acquaintances or merely strangers who happen to be in the same place at the same time. Therefore, while Spencer may have a stronger connection within the sports context, John could have a stronger connection upon building user A's social network, as illustrated in FIGS. 6A-6C.

According to some embodiments, the processes 400 and 500 involve applications of facial detection techniques, as discussed above, to form social connections between users, as illustrated in FIG. 5A and process 550. As discussed above, a user's photo collection is identified. Step 552. In some embodiments, facial recognition algorithms/techniques are then applied to the user's photo collection to separate photos/images having images of humans (or faces) in them from those images that do not. Step 554. In other words, facial recognition algorithms are applied to determine which images in the user's collection have depictions of human faces in them. In some embodiments, this involves the determination of other faces, not that of the primary user. From there, in some embodiments the processes 400 and 500 (e.g., process 550) would split into two branches of analysis. For the images that are determined to contain faces, facial recognition algorithms/techniques are applied to those images to recognize co-appearances of users, as discussed above. Step 556. Indeed, as discussed above, a determined co-appearance frequency of users within photos/images can be used to determine a strength of the social connection between users. Step 558. For the photos that were determined or identified to not have depictions of humans (no faces in the image, or no faces of other users besides the primary user's depiction), the above image clustering steps can be performed. Step 560. Thus, as discussed above, the number of photos belonging to the same cluster(s) is used as the strength of the social connection. Step 561. From here, social communities between users are built (or determined) through the use of a clique percolation algorithm (or other known or to be known algorithms/techniques for determining overlapping communities). Step 562. Indeed, overlapping community detection, as discussed herein, can apply logical topological properties of the social network connection between users via fast weighted or unweighted community detection analysis. The applications of the clique percolation algorithm, in some embodiments, allows for detecting k-clique communities between users at multiple thresholds, in order to simultaneously determine a representation (e.g., dendrogram) of a hierarchical community structure (as illustrated and discussed in relation to FIGS. 6A-6C).

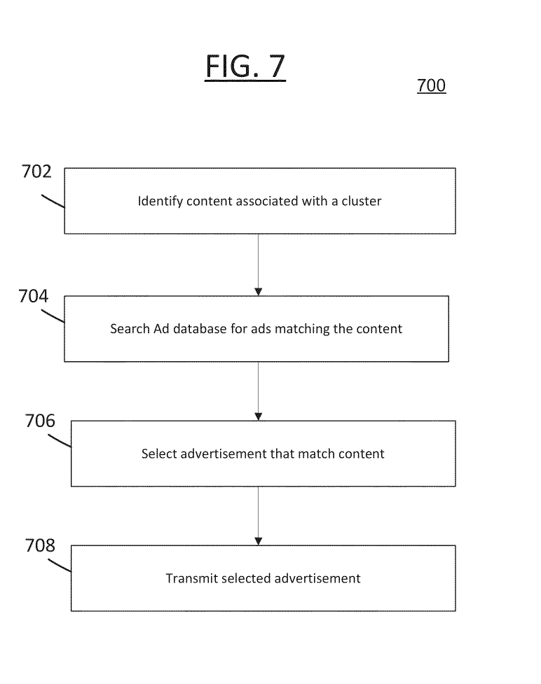

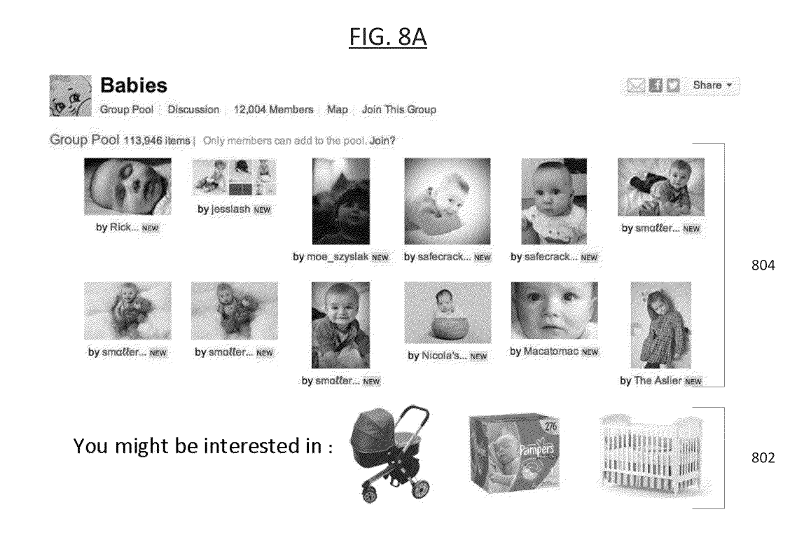

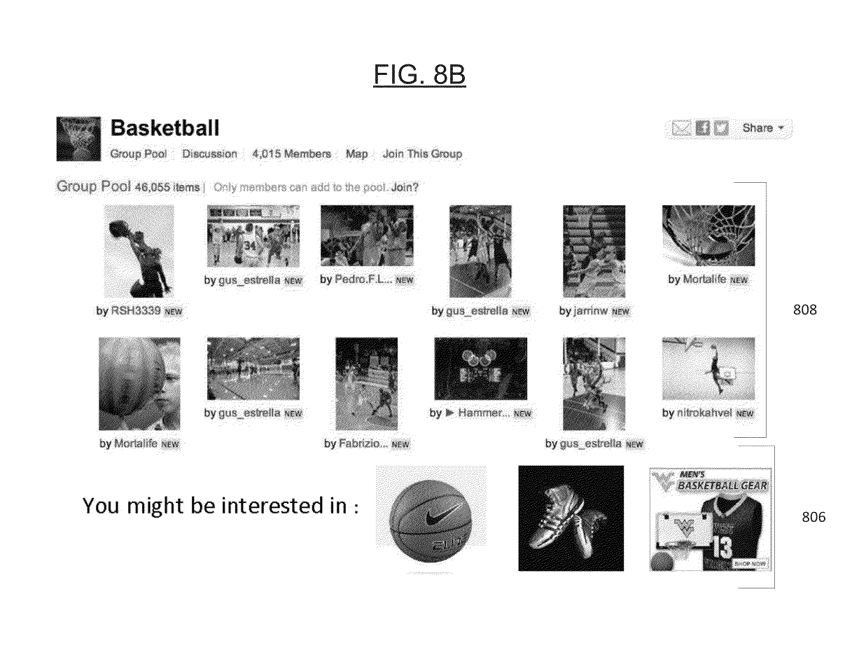

In Step 512, advertisements are served based on the compiled social network relationships. That is, advertisements are targeted to each group (or friends) based on the context for forming the group (as discussed further respective FIG. 7). In some embodiments, ads are served for each community (or group) based on the group characteristics. Step 564. From the above example, Spencer and user A have an established relationship based on sports. Therefore, within this context, and in some embodiments upon viewing sports images or a sports group page within online platform discussed herein (e.g., photo-sharing site), both users will be served ads related to sports. That is, as illustrated below in FIGS. 8A-8B, in some embodiments, upon any user viewing a group page based on a specific context (or content type), ads served will be directed to, or based upon, the context of the group page.

Turning to FIG. 6A, a flow illustration is shown of a hierarchical connections structure 600 based on the connections discussed above in process 500 of FIG. 5. As illustrated the closer the user is to user A within the hierarchical structure, the stronger the connection, as discussed above. As illustrated, user A is connected to user B, user C, and user D. These directly-connected users are considered to be first-level connections of user A. That is, they have a direct connection to user A and have the strongest connection to user A. Additionally, user C is directly connected to user B, and thereby provides both an indirect connection to user A and a direct connection previously noted. Therefore, an overlapping community may also exist between user A, B and C, as discussed above. User E and user F are connected to user B and user C respectively, but are not directly connected to user A. As such, user E and user F are considered to be indirect second-level connections of user A, which is representative of overlapping communities, as discussed above in FIG. 5. User G, user H, and user I are connected to one of the second level users and as such are considered to be indirect third-level connections to user A, which is representative of overlapping communities, as discussed above. Additional connection levels may also be provided, however, the illustrated connections are for exemplary purposes and not to be construed as limiting. It should be understood that the hierarchical connection structure 600 is presented relative to user A, however, analogous hierarchical connection structures can be established and illustrated relative to any of the other users within the photo-sharing site/platform.

Turning to FIGS. 6B and 6C, a graphic illustration of a built social networking is depicted according to the processes 400 and 500 discussed above. FIGS. 6B-6C are illustrative of the results from social connecting users based on instances of appearances within an image collection. From the above examples, user A was the primary user, however, for a real world illustration, President Barack Obama will be utilized as the primary user having an image collection for illustrative purposes. As illustrated in FIG. 6B, Barack Obama has a network of multiple users, each of whom appeared in an image within a cluster as discussed above, and the social strength of each connection to other users is proportional to the width of each connection pictured. In FIG. 6C, overlapped communities are depicted. As depicted, each person has a set of photos and their related photo tags. As shown, each of the circles corresponds to groups established based on recommendations as discussed above, and the links between people indicate that they are connected. As illustrated, there are overlapped communities for the immediate Obama family to government officials through a Barack Obama link.

Turning to FIG. 7, a work flow 700 of serving relevant advertisements to a group of users. As discussed above, a primary user's image collection is analyzed and specific content categories are identified from images of the collection. Based on these content categories, images are clustered and groups are formed (or recommended) to users. FIG. 7 illustrates how advertisements are served to a group of users based on the specific content categories. In Step 702, content from a cluster that formed the basis for the formation of a group between two users on the photo-sharing site is identified. That is, users were recommended to each other based on instances of users appearing in pictures having a similar context. This content (or context) is identified. In Step 704, the content (or content data) is communicated (or shared) from the photo-sharing platform to an advertisement server 130. Upon receipt of the content data, the advertisement server 130 performs a search for a relevant advertisement within an advertisement database 132. The search for an advertisement is based at least on the content utilized to form the cluster which predicated the formation of the user group (or friendship).

In Step 704, the advertisement server 130 searches the advertisement database 132 for advertisements that match the identified (and categorized) content. In Step 706, an advertisement is selected (or retrieved) based on the results of Step 704. In some embodiments, the advertisement can be selected based upon the result of Step 704, and modified to conform to attributes of the page upon which the advertisement will be displayed, and/or to the device for which it will be displayed. In some embodiments, as in Step 708, the selected advertisement is shared or communicated via the photo-sharing platform. In some alternative embodiments, the selected advertisement is sent directly to each user's computing device.

In non-limiting examples illustrating process 700, FIGS. 8A-8B illustrate examples of group pages on Flickr® having advertisements related to the group context. FIG. 8A illustrates advertisements, and a form of serving the advertisements to a group of users formed under the context of “babies.” That is, as discussed above, a group was joined by multiple users (e.g., 113,946 users as illustrated) based on their appearance in pictures/images having the context of “new born.” Thus, in this example, the Flickr® group page (or album) may display ads related to baby products, item 802. As depicted, item 804 shows images associated with members of the group which are related to the overall content of the group. In another illustrative example, FIG. 8B illustrates a group page on a photo-sharing site, e.g., Flickr®, for a group related to the context “basketball.” Item 806 shows that the ads are related to the context of basketball and item 808 shows a listing of some of the images from members of the group.

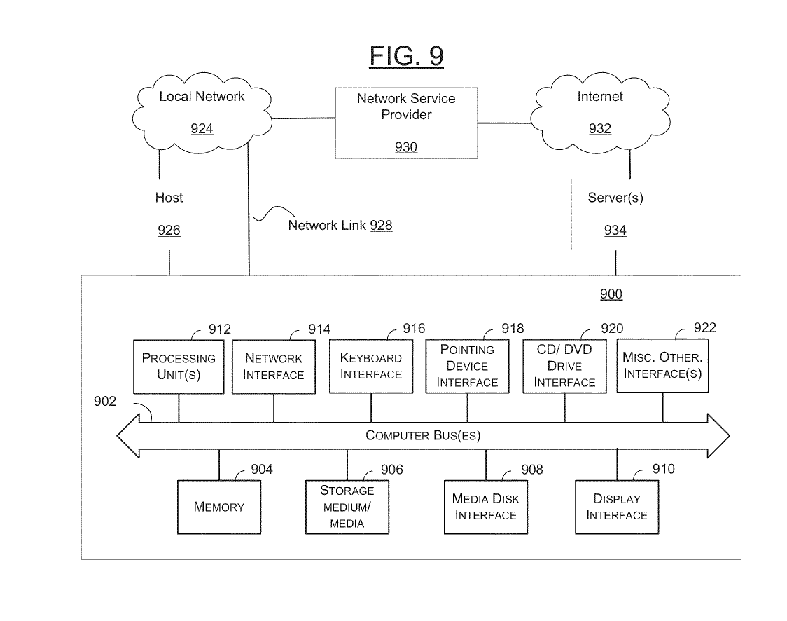

As shown in FIG. 9, internal architecture 900 includes one or more processing units, processors, or processing cores, (also referred to herein as CPUs) 912, which interface with at least one computer bus 902. Also interfacing with computer bus 902 are computer-readable medium, or media, 906, network interface 914, memory 904, e.g., random access memory (RAM), run-time transient memory, read only memory (ROM), media disk drive interface 920 as an interface for a drive that can read and/or write to media including removable media such as floppy, CD-ROM, DVD, media, display interface 910 as interface for a monitor or other display device, keyboard interface 916 as interface for a keyboard, pointing device interface 918 as an interface for a mouse or other pointing device, and miscellaneous other interfaces not shown individually, such as parallel and serial port interfaces and a universal serial bus (USB) interface.

Memory 904 interfaces with computer bus 902 so as to provide information stored in memory 904 to CPU 912 during execution of software programs such as an operating system, application programs, device drivers, and software modules that comprise program code, and/or computer executable process steps, incorporating functionality described herein, e.g., one or more of process flows described herein. CPU 912 first loads computer executable process steps from storage, e.g., memory 904, computer readable storage medium/media 906, removable media drive, and/or other storage device. CPU 912 can then execute the stored process steps in order to execute the loaded computer-executable process steps. Stored data, e.g., data stored by a storage device, can be accessed by CPU 912 during the execution of computer-executable process steps.

Persistent storage, e.g., medium/media 906, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 928 typically provides information communication using transmission media through one or more networks to other devices that use or process the information. For example, network link 928 may provide a connection through local network 924 to a host computer 926 or to equipment operated by a Network or Internet Service Provider (ISP) 930. ISP equipment in turn provides data communication services through the public, worldwide packet-switching communication network of networks now commonly referred to as the Internet 932.

A computer called a server host 934 connected to the Internet 932 hosts a process that provides a service in response to information received over the Internet 932. For example, server host 934 hosts a process that provides information representing video data for presentation at display 910. It is contemplated that the components of system 900 can be deployed in various configurations within other computer systems, e.g., host and server.

At least some embodiments of the present disclosure are related to the use of computer system 900 for implementing some or all of the techniques described herein. According to one embodiment, those techniques are performed by computer system 900 in response to processing unit 912 executing one or more sequences of one or more processor instructions contained in memory 904. Such instructions, also called computer instructions, software and program code, may be read into memory 904 from another computer-readable medium 906 such as storage device or network link. Execution of the sequences of instructions contained in memory 904 causes processing unit 912 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 900. Computer system 900 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 902 as it is received, or may be stored in memory 904 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, via a computing device, an image collection associated with a first user within a photo-sharing network;
parsing, via the computing device, each image in the image collection to identify content of each image;
determining, via the computing device, a first content category based on the content of each image;
grouping, via the computing device, each image associated with the first content category into a first image cluster;
analyzing, via the computing device, each image of the first cluster to determine an occurrence of a digital representation of a second user within the first cluster;
providing, via the computing device, a recommendation to the first user and the second user, said recommendation facilitating a social relationship between the first user and the second user within the photo-sharing network; and
serving, via the computing device, an advertisement to the first user and the second user in accordance with the recommendation and based on the first content category.

2. The method of claim 1, wherein said recommendation is an invitation for the first user to accept the second user as a friend on the photo-sharing network.

3. The method of claim 1, wherein said recommendation is an invitation to the first user and the second user to join a group, said group based on the first content category.

4. The method of claim 1, wherein said determination of said digital representation of the second user is based on profile information of the second user within the photo-sharing network.

5. The method of claim 1, further comprising:
determining a plurality of content categories based on said parsing of each image in the image collection; and
categorizing each image based on each determined content category.

6. The method of claim 5, further comprising:
determining whether each determined content category comprises a number of images equal to or above a threshold; and
creating an image cluster for each determined content category having the number of images equal to or above the threshold.

7. The method of claim 6, wherein said analyzing step is performed for each created image cluster.

8. The method of claim 1, wherein said occurrence of said digital representation of said second user satisfies a threshold by occurring at least a predetermined number of times.

9. The method of claim 1, wherein said social relationship between the first user and the second user is based, in part, on profile information of the first user.

10. The method of claim 1, further comprising:
identifying a connection between the second user and a third user within the photo-sharing network, said connection based upon the first content category; and
providing a second recommendation to the first user and the third user based on the connection between the second user and the third user.

11. The method of claim 1, wherein said analysis comprises applying a facial recognition algorithm to each image of the first image cluster.

12. A non-transitory computer-readable storage medium tangibly encoded with computer-executable instructions, that when executed by a processor of a computing device, perform a method comprising:
identifying an image collection associated with a first user within a photo-sharing network;
parsing each image in the image collection to identify content of each image;
determining a first content category based on the content of each image;
grouping each image associated with the first content category into a first image cluster;
analyzing each image of the first cluster to determine an occurrence of a digital representation of a second user within the first cluster;
providing a recommendation to the first user and the second user, said recommendation facilitating a social relationship between the first user and the second user within the photo-sharing network; and
serving an advertisement to the first user and the second user in accordance with the recommendation and based on the first content category.

13. The non-transitory computer-readable storage medium of claim 12, wherein said recommendation is an invitation for the first user to accept the second user as a friend on the photo-sharing network.

14. The non-transitory computer-readable storage medium of claim 12, wherein said recommendation is an invitation to the first user and the second user to join a group, said group based on the first content category.

15. The non-transitory computer-readable storage medium of claim 12, wherein said determination of said digital representation of the second user is based on profile information of the second user within the photo-sharing network.

16. The non-transitory computer-readable storage medium of claim 12, further comprising:
determining a plurality of content categories based on said parsing of each image in the image collection;
categorizing each image based on each determined content category;
determining whether each determined content category comprises a number of images equal to or above a threshold; and
creating an image cluster for each determined content category having the number of images equal to or above the threshold, wherein said analyzing step is performed for each created image cluster.

17. The non-transitory computer-readable storage medium of claim 12, wherein said occurrence of said digital representation of said second user satisfies a threshold by occurring at least a predetermined number of times.

18. The non-transitory computer-readable storage medium of claim 12, further comprising:
identifying a connection between the second user and a third user within the photo-sharing network, said connection based upon the first content category; and
providing a second recommendation to the first user and the third user based on the connection between the second user and the third user.

19. A system comprising:
at least one computing device comprising:
memory storing computer-executable instructions; and
one or more processors for executing said computer-executable instructions, comprising:
identifying an image collection associated with a first user within a photo-sharing network;
parsing each image in the image collection to identify content of each image;
determining a first content category based on the content of each image;
grouping each image associated with the first content category into a first image cluster;
analyzing each image of the first cluster to determine an occurrence of a digital representation of a second user within the first cluster;
providing a recommendation to the first user and the second user, said recommendation facilitating a social relationship between the first user and the second user within the photo-sharing network; and
serving an advertisement to the first user and the second user in accordance with the recommendation and based on the first content category.

20. The system of claim 19, further comprising:
determining a plurality of content categories based on said parsing of each image in the image collection;
categorizing each image based on each determined content category;
determining whether each determined content category comprises a number of images equal to or above a threshold; and
creating an image cluster for each determined content category having the number of images equal to or above the threshold, wherein said analyzing step is performed for each created image cluster.
